(19) United States
(12) Patent Application Publication
(10) Pub. No.: US 2026/0072545 A1
(43) Pub. Date: Mar. 12, 2026

(54) ELECTRONIC DEVICE, OPTICAL COMPENSATION SYSTEM, AND ELECTRONIC DEVICE DRIVING METHOD

(71) Applicant: Samsung Display Co., Ltd., Yongin-si (KR)

(72) Inventors: Yoshiyuki KUROKAWA, Yokohama-shi (JP); Yasuhiko SHINKAJI, Yokohama-shi (JP)

(21) Appl. No.: 19/320,340

(22) Filed: Sep. 5, 2025

(30) Foreign Application Priority Data
Sep. 12, 2024 (JP) 2024-158395
Dec. 3, 2024 (JP) 2024-210490

(51) Int. Cl. G06F 3/041

(52) U.S. Cl. CPC G06F 3/0418

(57) ABSTRACT

An electronic device includes: a display panel comprising a plurality of pixels and a plurality of sensors; a sensor driving circuit configured to drive the plurality of sensors; a decoder configured to receive coordinate information about an arbitrary area from the sensor driving circuit; and a memory configured to receive memory coordinate information corresponding to the arbitrary area and a read command signal from the decoder, and to output corresponding compression compensation data to the decoder, wherein the decoder includes: a first memory configured to store information for reconstruction of the compression compensation data; a reconstruction circuit configured to use the compression compensation data and the necessary information for reconstruction to output reconstruction compensation data; and a second memory configured to receive the reconstruction compensation data from the reconstruction circuit, to store the reconstruction compensation data, and to output the reconstruction compensation data to the sensor driving circuit.

### CROSS-REFERENCE TO RELATED APPLICATIONS

The present application claims priority to and the benefit of Japanese Patent Application No. JP2024-158395, filed on Sep. 12, 2024, and Japanese Patent Application No. JP2024-210490, filed on Dec. 3, 2024, in the Japan Patent Office, the entire disclosures of each of which are incorporated herein by reference.

### BACKGROUND

Aspects of some embodiments of the present disclosure herein relate to an optical compensation system, an electronic device including the optical compensation system, and an electronic device driving method.

Electronic devices, which may display an image such as a television, a mobile phone, a tablet computer, a navigator, a game device and the like, may adopt a touch-based input method enabling a user to intuitively and conveniently input information or commands, other than a typical method such as buttons, a keyboard, a mouse or the like.

Recently, as a user authentication means for online banking, product purchase, security, or the like, a method for utilizing a fingerprint, which is one of pieces of biometric information, has been proposed, and a display device with a fingerprint recognition function is increasingly requested.

An optical sensor used for fingerprint recognition, a document scan, or the like may be included separately from a display panel in an electronic device. Recently, a technology has been proposed for implementing, in one display panel, pixels for displaying an image and light sensing elements (or optical sensors) for sensing light.

The above information disclosed in this Background section is only for enhancement of understanding of the background and therefore the information discussed in this Background section does not necessarily constitute prior art.

### SUMMARY

Aspects of some embodiments of the present disclosure include an optical compensation system, an electronic device including the optical compensation system, and an electronic device driving method.

According to some embodiments of the present disclosure, an electronic device includes a display panel including a plurality of pixels and a plurality of sensors, a sensor driving circuit configured to drive the plurality of sensors, a decoder configured to receive coordinate information about an arbitrary area from the sensor driving circuit, and a memory configured to receive memory coordinate information corresponding to the arbitrary area and a read command signal from the decoder, and to output corresponding compression compensation data to the decoder, wherein the decoder may include a first memory configured to store necessary information for reconstruction of the compression compensation data, a reconstruction circuit configured to use the compression compensation data and the necessary information for reconstruction to output reconstruction compensation data, and a second memory configured to receive the reconstruction compensation data from the reconstruction circuit, to store the reconstruction compensation data, and to output the reconstruction compensation data to the sensor driving circuit.

According to some embodiments, the sensor driving circuit may be configured to receive sensor signals from the plurality of sensors, and to convert the sensor signals to generate sensor data, and the sensor driving circuit may be configured to perform optical compensation calculation on the sensor data using the reconstruction compensation data to generate optically compensated sensor data.

According to some embodiments, the first memory may include a (1-1)-th memory, a (1-2)-th memory, a (1-3)-th memory, a (1-4)-th memory, a (1-5)-th memory, and a (1-6)-th memory configured to store different pieces of the necessary information for reconstruction.

According to some embodiments, the reconstruction compensation data may include offset data and gain data.

According to some embodiments, the second memory may include a (2-1)-th memory configured to store the offset data and a (2-2)-th memory configured to store the gain data.

According to some embodiments, each of the plurality of sensors may be an optical sensor.

According to some embodiments, the arbitrary area may be a necessary area for fingerprint authentication.

According to some embodiments, a period in which the necessary information for reconstruction is output from the first memory to the reconstruction circuit may overlap an overhead period.

According to some embodiments, the necessary information for reconstruction may be encoding table data.

According to some embodiments, the necessary information for reconstruction may be quantization error correction data.

According to some embodiments, the necessary information for reconstruction may be outlier data.

According to some embodiments, the memory may be a non-volatile memory, and the first memory and the second memory may be volatile memories.

According to some embodiments, the compression compensation data may be data in which alternating current component data is compressed, and the alternating current component data may be data excluding direct current component data from optical compensation data.

According to some embodiments of the present disclosure, an optical compensation system includes a decoder configured to receive coordinate information about an arbitrary area, and a memory configured to receive memory coordinate information corresponding to the arbitrary area and a read command signal from the decoder, and to output corresponding compression compensation data to the decoder, wherein the decoder may include a first memory configured to store necessary information for reconstruction of the compression compensation data, a reconstruction circuit configured to use the compression compensation data and the necessary information for reconstruction to output reconstruction compensation data, and a second memory configured to receive the reconstruction compensation data from the reconstruction circuit, store the reconstruction compensation data, and to output the reconstruction compensation data, wherein the memory may be a non-volatile memory, and the first memory and the second memory may be volatile memories.

According to some embodiments, the arbitrary area may be a necessary area for fingerprint authentication.

According to some embodiments, a period in which the necessary information for reconstruction is output from the first memory to the reconstruction circuit may overlap an overhead period.

According to some embodiments, the necessary information for reconstruction may be encoding table data, quantization error correction data, or outlier data.

According to some embodiments of the present disclosure, an electronic device driving method includes identifying an arbitrary area in contact with an object, identifying ROM addresses corresponding to coordinate information about the arbitrary area, performing continuous reading of data from a leading address of the ROM addresses, reconstructing compression compensation data, which has been read, using necessary information for reconstruction to generate reconstructed data, and performing optical compensation calculation on sensor data using the reconstructed data to generate optically compensated sensor data.

According to some embodiments, the performing continuous reading of data from a leading address of the ROM addresses may include calculating a number of bits of unnecessary leading data, calculating a number of bits of unnecessary final data, and calculating a number of clocks necessary for the reading.

According to some embodiments, the reconstructing may include comparing representative value data corresponding to coordinates (X₀+i, Y₀+j) with pieces of representative value data corresponding to row Y₀+j, reconstructing, using outlier data, the compression compensation data of coordinates having the outlier data among the data of row Y₀+j when there is the outlier data, reconstructing the compression compensation data using the corresponding representative value data when there is not the outlier data, and repeating the reconstruction of an unreconstructed row when the reconstruction of the pieces of data of row Y₀+j is finished.

### BRIEF DESCRIPTION OF THE DRAWINGS

The accompanying drawings are included to provide a further understanding of aspects of some embodiments of the present disclosure, and are incorporated in and constitute a part of this specification. The drawings illustrate aspects of some embodiments of the present disclosure and, together with the description, serve to explain aspects of some embodiments of the present disclosure. In the drawings:

FIG. 1 is a perspective view of an electronic device according to some embodiments of the present disclosure;

FIG. 2 is a block diagram of an electronic device according to some embodiments of the present disclosure;

FIG. 3 is a block diagram of an optical compensation system according to some embodiments of the present disclosure;

FIG. 4 is a plan view of a sensor area according to some embodiments of the present disclosure;

FIG. 5 is a flowchart of an optical compensation system according to some embodiments of the present disclosure;

FIG. 6A is a graph for explaining an optical compensation data compression algorithm according to some embodiments of the present disclosure;

FIG. 6B is a graph for explaining an optical compensation data compression algorithm according to some embodiments of the present disclosure.

FIG. 7 is a flowchart for explaining a reconstruction algorithm according to some embodiments of the present disclosure;

FIG. 8A is a drawing for explaining a ROM address calculation method according to some embodiments of the present disclosure;

FIG. 8B is a drawing for explaining a ROM address calculation method according to some embodiments of the present disclosure; and

FIG. 9 is a block diagram of a decoder design according to some embodiments of the present disclosure.

### DETAILED DESCRIPTION

It will be understood that when an element or layer is referred to as being “on”, “connected to” or “coupled to” another element or layer, it can be directly on, connected or coupled to the other element or intervening third elements may be present.

Like reference numerals in the drawings refer to like elements. In addition, in the drawings, the thickness and the ratio and the dimension of the element are exaggerated for effective description of the technical contents. The term “and/or” includes any and all combinations of one or more of the associated items.

Terms such as first, second and the like may be used to describe various components, but these components should not be limited by the terms. Such terms are only used for distinguishing one element from other elements. For instance, a first component may be referred to as a second component, or similarly, a second component may be referred to as a first component, without departing from the scope of the present disclosure. The singular expressions include plural expressions unless the context clearly dictates otherwise.

In addition, the terms such as “under”, “lower”, “on” and “upper” are used for explaining associations of items illustrated in the drawings. The terms are used as a relative concept and are described with reference to the direction indicated in the drawings.

It should be understood that the terms “comprise” or “have” are intended to specify the presence of stated features, integers, steps, operations, elements, components, or combinations thereof in the disclosure, but do not preclude the presence or addition of one or more other features, integers, steps, operations, elements, components, or combinations thereof.

Terms of “part” or “unit” means a software component or hardware component performing specific functions. The hardware component may include, for example, a field-programmable gate array (FPGA) or an application-specific integrated circuit (ASIC). The software component may refer to an executable code and/or data used by an executable code in an addressable recording medium. Accordingly, software components may be, for example, object-oriented software components, class components, and task components, and include processors, functions, attributes, procedures, subroutines, program code segments, drivers, firmwares, microcodes, circuits, data, databases, data structures, tables, arrays, or variables.

Unless otherwise defined, all terms (including technical and scientific terms) used herein have the same meaning as commonly understood by one of ordinary skill in the art to which the present inventive concept belong. In addition, it will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments of the inventive concept will be described with reference to the accompanying drawings.

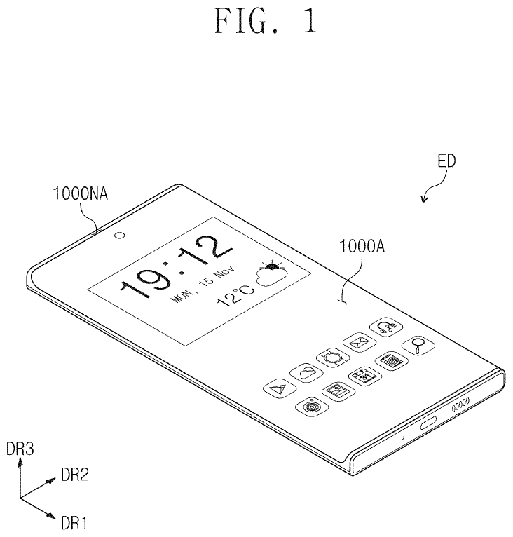

FIG. 1 is a perspective view of an electronic device ED according to some embodiments of the present disclosure.

Referring to FIG. 1, the electronic device ED may be a device activated in response to an electrical signal. For example, the electronic device ED may be a mobile phone, a foldable mobile phone, a notebook computer, a television, a tablet computer, a vehicle navigator, a game device, or a wearable device, but is not limited thereto. In FIG. 1, the electronic device ED is illustrated as a mobile phone.

The electronic device ED may be defined with an active area 1000A and a non-active area 1000NA. The electronic device ED may display images via the active area 1000A. The active area 1000A may include a surface defined by a first direction DR1 and a second direction DR2. The non-active 1000NA may surround the periphery (e.g., outside a footprint) of the active area 1000A. According to some embodiments of the present disclosure, the non-display area 1000NA may be omitted. For example, the active area 1000A may be an area at which images are displayed, and the non-active area 1000NA may be an area at which images are not displayed.

The thickness direction of the electronic device ED may be parallel to a third direction DR3 that intersects with the first direction DR1 and the second direction DR2. Accordingly, the front surfaces (or top surfaces) and the rear surfaces (or bottom surfaces) of members included in the electronic device ED may be defined on the basis of the third direction DR3.

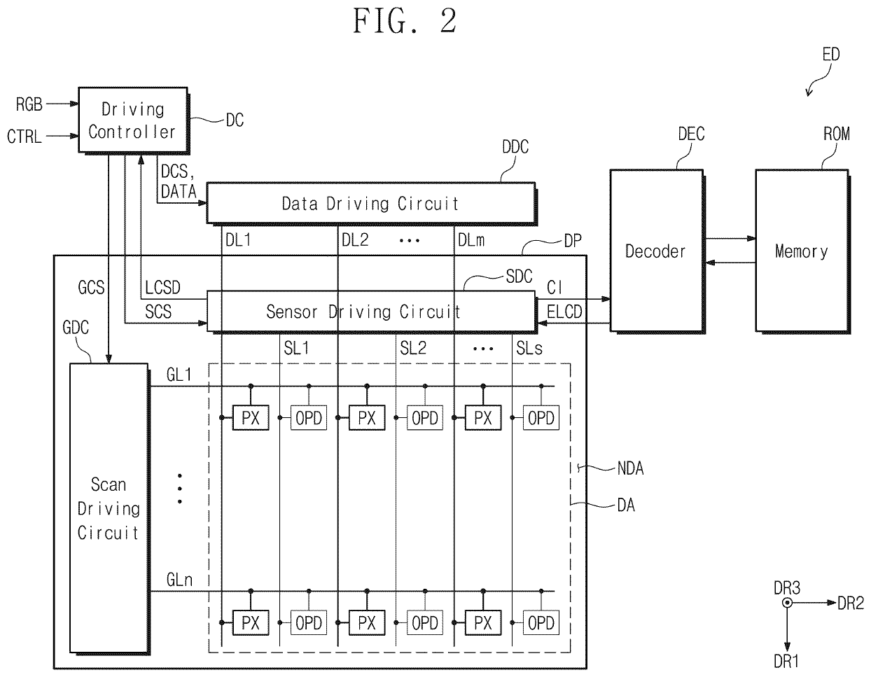

FIG. 2 is a block diagram of the electronic device ED according to some embodiments of the present disclosure.

Referring to FIG. 2, the electronic device ED may include a display panel DP, a driving controller DC, a data driving circuit DDC, a scan driving circuit GDC, a sensor driving circuit SDC, a decoder DEC, and a memory ROM.

According to some embodiments of the present disclosure, each of the driving controller DC, the data driving circuit DDC, the scan driving circuit GDC, the sensor driving circuit SDC, the decoder DEC, and the memory ROM may be implemented with an integrated circuit (IC) to be electrically connected to the display panel DP. Alternatively, some of the data driving circuit DDC, the scan driving circuit GDC, or the sensor driving circuit SDC may be embedded in a prescribed region of the display panel DP.

In addition, according to some embodiments of the present disclosure, the sensor driving circuit SDC and the decoder DEC may be implemented with one integrated chip, or individual chips separated from each other. In addition, the sensor driving circuit DEC, the decoder DEC, and the memory ROM may be implemented with one integrated chip, or individual chips separated from each other.

The driving controller DC may receive an input image signal RGB and a control signal CTRL. The driving controller DC generates an output image signal DATA by converting the data format of the input image signal RGB so as to be suitable for the data driving circuit DDC and the display panel DP. The driving controller DC may output scan control signals GCS, data control signals DCS, and sensor control signals SCS.

The data driving circuit DDC may receive the data control signal DCS and the output image signal DATA from the driving controller DC. The data driving circuit DDC may convert the output image signal DATA into data signals, and outputs the data signals to a plurality of data lines DL1 DL2, . . . , DLm to be described below. The data signals may be analog voltages corresponding to grayscale levels of the output image signal DATA.

The display panel DP may include a plurality of scan lines GL1 to GLn, the plurality of data lines DL1 to DLm, a plurality of sensor lines SL1 to SLs, a plurality of pixels PX, and a plurality of sensors OPD, where m may be an integer or 3 or greater, n may be an integer of 2 or greater, and s may be an integer of 2 or greater.

The display layer DP may include a display area DA corresponding to the active area 1000A (see FIG. 1) and a non-display area NDA corresponding to the non-active area 1000NA (see FIG. 1). The pixels PX and the sensors OPD may be arranged in the display area DA.

The scan driving circuit GDC and the sensor driving circuit SDC may be arranged in the non-display area NDA of the display panel DP. However, embodiments of the present disclosure are not limited thereto, and a portion of the scan driving circuit DSC and the sensor driving circuit SDC may be arranged in the display area DA and outside the display panel DP. According to some embodiments of the present disclosure, the scan driving circuit GDC may be arranged adjacent to one side surface of the display area DA in the display panel DP, and the sensor driving circuit SDC may be arranged adjacent to another side surface of the display area DA in the display panel DP.

The scan driving circuit GDC may receive the scan control signal GCS from the driving controller DC. In response to the scan control signal GCS, the scan driving circuit GDC may output scan signals to the scan lines GL1 to GLn. Each of the scan lines GL1 to GLn may extend from the scan driving circuit GDC in the second direction DR2, and be arranged to be spaced apart from each other in the first direction DR1. The data lines DL1 to DLm may extend from the data driving circuit DDC in the first direction DR1, and be arranged to be spaced apart from each other in the second direction DR2.

The pixels PX may be respectively electrically connected to the scan lines GL1 to GLn and the data lines DL1-DLm. In FIG. 2, one pixel is illustrated as being connected to any one of the scan lines GL1 to GLn, but embodiments of the present disclosure are not limited thereto. For example, one pixel PX may be connected to multiple scan lines among the scan lines GL1 to GLn.

The sensors OPD may be respectively electrically connected to the sensor lines SL1 to SLs. One sensor OPD may be electrically connected to one scan line, for example, one write scan line among the scan lines GL1 to GLn. However, embodiments of the present disclosure are not limited thereto, and the number of scan lines respectively connected to the sensors OPD may vary. Each of the sensors OPD may be provided through the same processes as those of the pixels. In addition, the number of sensors OPD may be the same as or different from that of the pixels PX.

According to some embodiments of the present disclosure, the sensors OPD may include optical sensors, and sense a fingerprint via the optical sensors. A sensor signal may be optical information (luminance information) acquired by the optical sensors, and may be a biometric detection signal or a document scan signal including biometric information such as a fingerprint of a user. For example, the sensors OPD may emit light, and sense an object such as the fingerprint by receiving light that has been emitted and is reflected by the object such as a finger to be returned. For example, a sensed result by the sensors OPD may be an image captured of the object such as the fingerprint or the like. In addition, the sensed result by the sensors OPD may be data obtained by sensing the object, or data represented by a numerical value or the like.

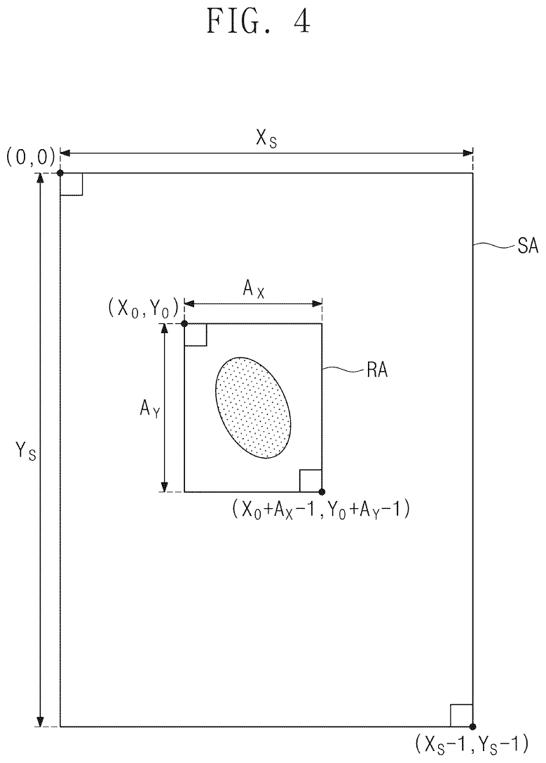

The sensor driving circuit SDC may receive the scan control signal SCS from the driving controller DC. The sensor driving circuit SDC may receive sensor signals from the sensors OPD in response to the sensor control signal SCS via the sensor lines SL1 to SLs. The sensor driving circuit SDC may perform analog-digital conversion on the sensor signals received from the sensor lines SL1 to SLs to generate sensor data (sensor data before the optical compensation). Based on the sensor signal (the sensor signal before optical compensation) from the sensors OPD, or the sensor data (the sensor data before optical compensation) converted from the sensor signal, the sensor driving circuit SDC may determine whether the object (a target object) such as the finger contacts the display panel DP, or identify an arbitrary area RA (see FIG. 4) as the contact area. According to embodiments of the present disclosure, an “arbitrary area” may be an area corresponding to, or at which, an external object (e.g., a user's finger) contacts the display panel DP.

According to some embodiments of the present disclosure, the memory ROM may store compressed optical compensation data. The optical compensation data may be required to compensate for the data received from the sensors OPD. For example, each of the sensors OPD may have a prescribed deviation, and the optical compensation data may be data for compensating for the deviation. For example, each of the sensors OPD may not have the completely same sensor sensitivity, and have deviations in sensor sensitivity or the like between the sensors OPD. The optical compensation data may be used to compensate for the deviations in sensor sensitivity or the like between the sensors OPD, and to prevent or reduce a deviation in display quality in the display area DA.

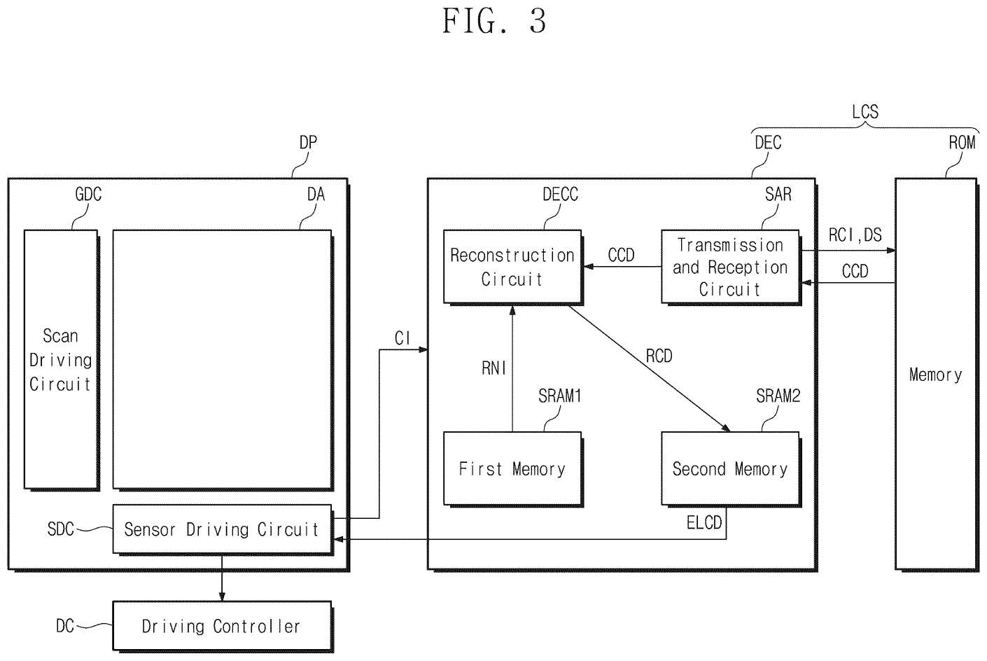

Alternatively, the optical compensation data may be data for increasing finger sensing sensitivity using the sensors OPD. The memory ROM may compress, namely, encode the optical compensation data generated based on information obtained by measuring in advance sensitivity information about the sensors OPD, and store in advance the encoded data. Hereinafter, the compressed optical compensation data may be referred to as compression compensation data CCD (see FIG. 3).

The decoder DEC may transmit and receive signals to and from the memory ROM. In addition, the decoder DEC may receive, from the memory, necessary data, for example, the compression compensation data CCD (see FIG. 3) corresponding to the arbitrary area RA (see FIG. 4). The decoder DEC may perform conversion on the received data, for example, the compression compensation data CCD (see FIG. 3) corresponding to the arbitrary area RA (see FIG. 4), and output the optical compensation data ELCD to the sensor driving circuit SDC. The signal transmission and reception between the decoder DEC and the memory ROM, and the conversion of the received data will be described below with reference to FIG. 3.

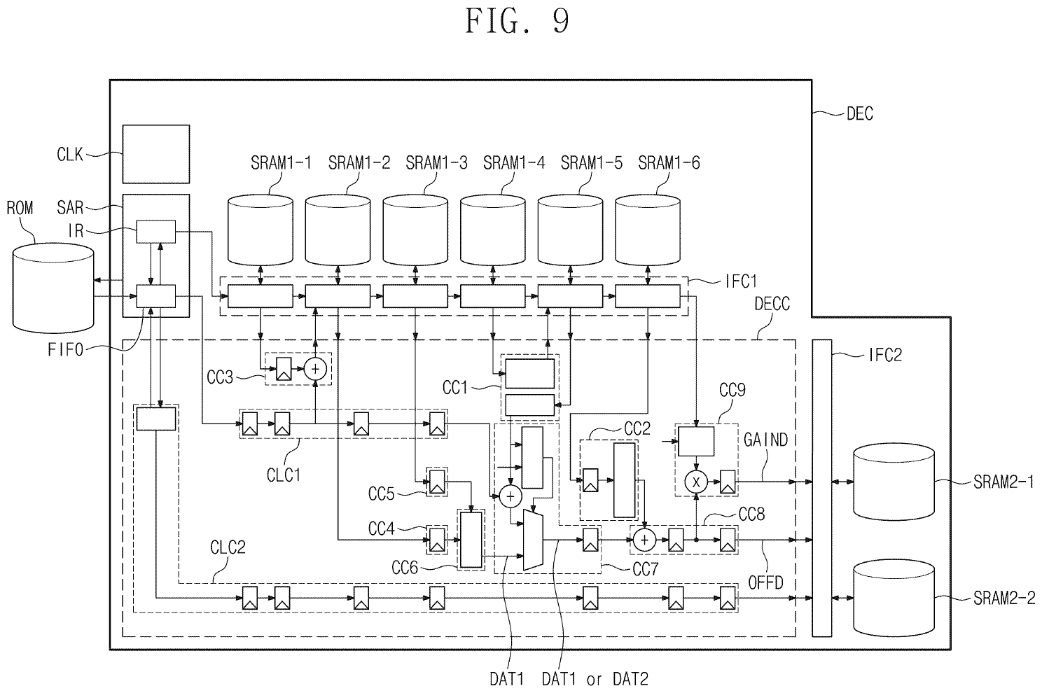

According to some embodiments of the present disclosure, the sensor driving circuit SDC may output coordinate information (CI) required for optical compensation to the decoder DEC, and receive the optical compensation data ELCD from the decoder DEC. The sensor driving circuit SDC may use the received optical compensation data ELCD to perform optical compensation calculation on the sensor data (the sensor data before the optical compensation), thereby generating optically compensated sensor data LCSD. By way of an example of the optical compensation calculation, when the sensor data is x, gain data GAIND (see FIG. 9) is a, and offset data OFFD (see FIG. 9) is b, the optical compensation data y may be calculated according to an equation y=a (x−b)+c (where c is a constant number). The optically compensated sensor data LCSD may be output from the sensor driving circuit SDC.

FIG. 2 shows an example case in which the optically compensated sensor data LCSD is output to the driving controller DC, but embodiments of the present disclosure are not particularly limited thereto. The optically compensated sensor data LCSD may be used to generate a captured image, or a captured and optically compensated image.

FIG. 3 is a block diagram of an optical compensation system LCS according to some embodiments of the present disclosure. FIG. 4 is a plan view showing the sensor area SA according to some embodiments of the present disclosure.

Referring to FIGS. 2, 3, and 4, the sensors OPD may be arranged along the first direction DR1 and the second direction DR2 in the sensor area SA. The sensor area SA may correspond to the display area DA, but is not limited thereto. For example, the sensor area SA may have a smaller area than the display area DA.

The optical compensation system LCS may include the memory ROM and the decoder DEC.

The memory ROM may store the compression compensation data CCD. According to some embodiments of the present disclosure, the memory ROM may be a non-volatile memory, such as a memory read only memory (ROM) or an electrically erasable programmable read only memory (EEPROM). In storing the compression compensation data CCD, the memory cost may be relatively reduced using a relatively low cost ROM.

According to some embodiments of the present disclosure, the compression compensation data CCD may be stored in order in the memory ROM according to the coordinates of the sensors OPD arranged in the sensor area SA. Here, a storage method of the compression compensation data CCD may include a column-order method, a row-order method, and a tile-order method. Referring to the sensor area SA shown in FIG. 4, the optical compensation data for the coordinates from (0, 0) to (X_{S}−1, Y_{S}−1) may be compressed and stored in the memory ROM. For example, the column-order method may be a method for compressing the optical compensation data and storing the compressed data in the order of (0, 1), (0, 2), . . . , (0, Y_{S}−1) on the basis of the coordinates (0, 0). The row-order method may be a method for compressing the optical compensation data and storing the compressed data in the order of (1, 0), (2, 0), . . . , (X_{S}−1, 0) on the basis of the coordinates (0, 0).

In addition, the tile-order method may be a method for partitioning (or dividing into blocks) the sensor area SA into a tile shape and storing in order. For example, one row, a plurality of rows, or a plurality of rows×a plurality of columns may be included in one tile. In the memory ROM, the optical compensation data arranged in a row and column order is compressed and stored using, as leading data, the optical compensation data at the left upper end coordinates of each tile. The more the number of pieces of data included in one tile is, the higher the compression ratio becomes. Accordingly, when the tile is implemented to have a large size, the compression ratio becomes higher, and as the compression ratio becomes higher, the amount of the compression compensation data CCD stored in the memory ROM becomes smaller. Accordingly, it is advantageous in terms of the storage space and the cost.

Namely, the sensor area SA may be partitioned into, for example, a plurality of tiles in which each of the tiles includes a plurality of rows, a plurality of rows×a plurality of columns, or the like. In addition, by compressing, into one, the compression compensation data CCD corresponding to one tile, for example, a plurality of pieces of compression compensation data CCD corresponding to a plurality of rows, a plurality of rows×a plurality of columns, or the like, and furthermore, by increasing the number of the pieces of compression compensation data CCD included in the one tile, the number of the pieces of compression compensation data CCD after compression may be relatively reduced in the entire sensor area SA. Accordingly, the data compression ratio of the entire sensor area SA may be increased.

According to some embodiments of the present disclosure, the decoder DEC may include a transmission and reception circuit SAR, a reconstruction circuit DECC, a first memory SRAM1, and a second memory SRAM2.

The transmission and reception circuit SAR may transmit and receive signals between the decoder DEC and the memory ROM. The transmission and reception circuit SAR may be referred to as an interface circuit.

According to some embodiments of the present disclosure, the memory ROM may store the compression compensation data CCD for the coordinates of the entire sensor area SA, and the decoder DEC may selectively receive a required portion of the total compression compensation data (CCD).

Referring to the sensor area SA shown in FIG. 4, the arbitrary area RA may be defined in the sensor area SA. The arbitrary area RA may be referred to as a target area or a prescribed area. The arbitrary area RA may be an area from (X₀, Y₀) to (X₀+Aₓ−1, Y₀+A_{y}−1). The arbitrary area RA may be an area only including, for example, an area required for fingerprint authentication, and include an area in contact with a finger and the surrounding area thereof. The arbitrary area RA may be a portion of the sensor area SA.

The arbitrary area RA may be identified in various methods. For example, the arbitrary area RA may be determined by images captured by the sensors OPD. Here, an area of the image acquired of the object such as a fingerprint by the sensors OPD, or an area including the area of the image may be used as the arbitrary area RA.

Alternatively, the display panel DP may further include a sensor layer configured to detect an external input, wherein the sensor layer may be a self-capacitance sensor or a mutual-capacitance sensor. In this case, an area in which a touch occurs may be identified using the sensor layer on the basis of a change in capacitance. In addition, the arbitrary area RA may be determined as an area overlapping the area in which the touch occurs. Otherwise, an identification method is not limited as long as the arbitrary area may be identified.

The transmission and reception circuit SAR of the decoder DEC may receive the compression compensation data CCD required to compensate the sensors OPD arranged in the sensor area SA. According to some embodiments of the present disclosure, the transmission and reception circuit SAR may only receive the compression compensation data CCD required to compensate the sensors OPD arranged in the arbitrary area RA. The compression compensation data CCD required to compensate the sensors OPD arranged in the arbitrary area RA may be referred to as the compression compensation data CCD corresponding to the arbitrary area RA.

The reconstruction circuit DECC may receive the compression compensation data CCD received from the memory ROM via the transmission and reception circuit SAR, namely, the compression compensation data CCD corresponding to the arbitrary area RA. The reconstruction circuit DECC may reconstruct, namely, decode the received compression compensation data CCD corresponding to the arbitrary area RA. Here, the reconstruction circuit DECC may receive necessary information for reconstruction RNI (or information or data indication reconstruction information regarding reconstruction) from the first memory SRAM1.

According to some embodiments of the present disclosure, the reconstruction circuit DECC may reconstruct only the compression compensation data CCD corresponding to the arbitrary area RA received from the memory ROM. Here, the necessary information for reconstruction RNI received from the first memory SRAM1 may be the necessary information RNI for reconstructing the compression compensation data CCD corresponding to the arbitrary area RA.

The reconstruction circuit DECC may reconstruct the compression compensation data (CCD) using the necessary information for reconstruction RNI. The data reconstructed from the reconstruction circuit DECC may be output to the second memory SRAM2. Hereinafter, the reconstructed data may be referred to as reconstruction compensation data RCD.

When the reconstruction circuit DECC reconstructs the compression compensation data CCD, the first memory SRAM1 may store the necessary information for reconstruction RNI. For example, the necessary information for reconstruction RNI may include encoding table data, quantization error correction data, outlier data, mean value data, or the like.

In compressing the optical compensation data, the encoding table data may be conversion table data for decoding when an encoding process is used. The encoding may mean the aforementioned compression, and the decoding may mean the aforementioned reconstruction, namely.

In compressing the optical compensation data, the quantization error correction data may be data for correcting a quantization error when a nonlinear quantization process is used. The quantization may be a process for sectioning amplitude intervals of an analog signal and representing the same as representative values. According to some embodiments of the present disclosure, unlike linear quantization, the nonlinear quantization may mean that step intervals become different so that generation frequencies of analog signals included in respective sections become same. Accordingly, because an analog signal having a low generation frequency has a large quantization error, the nonlinear quantization precisely corrects the quantization error in such data using quantization error correction data.

The outlier data may be data of which the generation frequency is remarkably low in the optical compensation data, and may be data deviating far from a range. When the aforementioned encoding is used for compressing the optical compensation data, a compression ratio may be degraded when the outlier data is encoded. Accordingly, the outlier data may be excluded from the encoding process. In addition, the outlier data may be separately stored using the coordinates of the outlier data. The generation frequency of the separately stored outlier data is low, and thus the amount of the stored data is also small to become advantageous in terms of the storage space.

The mean value data may be the mean value for each column, each row, or each tile of the optical compensation data. The mean value data may include approximation data of a linear function or approximation data of a broken line. According to some embodiments of the present disclosure, when taking the mean value data for each row as an example, the approximation data of the linear function may be an intercept value or a slope value in an optical compensation data graph for each row. In addition, the approximation data of the broke line may be data values of both ends for each division of the optical compensation data graph for each row. Here, it may be easy to increase the compression ratio by compressing the difference data between the optical compensation data and the mean value data.

The necessary information for reconstruction RNI may be stored in advance in the first memory SRAM1. The necessary information for reconstruction RNI may be output from the first memory SRAM1 to the reconstruction circuit DECC. Namely, the first memory SRAM1 may store in advance the necessary information for reconstruction RNI in a range of the sensor area SA of FIG. 4. Information such as coordinate information CI for the arbitrary area RA may be received by the first memory SRAM1 via the transmission and reception circuit SAR from the reconstruction circuit DECC. Accordingly, based on the coordinate information CI for the arbitrary area RA or the like, the first memory SRAM1 may output, to the reconstruction circuit DECC, the necessary information RNI for reconstructing the compression compensation data CCD corresponding to the arbitrary area RA among the necessary information for reconstruction RNI for the entire sensor area SA.

The second memory SRAM2 may receive and store the reconstruction compensation data RCD reconstructed by the reconstruction circuit DECC. The second memory SRAM2 may output the stored reconstruction compensation data RCD as the optical compensation data ELCD to the sensor driving circuit SDC. The reconstruction compensation data RCD and the optical compensation data ELCD may correspond to the arbitrary area RA.

According to some embodiments of the present disclosure, the first memory SRAM1 and the second memory SRAM2 may be volatile memories. The first memory SRAM1 and the second memory SRAM2 may be static random access memories.

According to some embodiments of the present disclosure, the sensor driving circuit SDC may receive the optical compensation data ELCD from the second memory SRAM2.

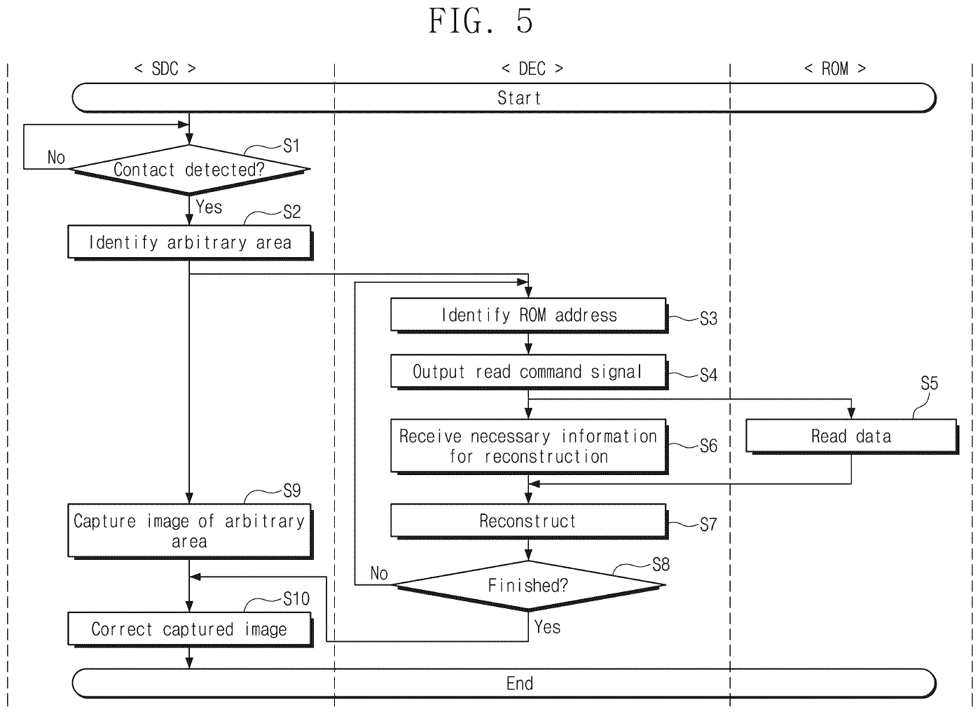

FIG. 5 is a flowchart showing aspects of an operation of the optical compensation system according to some embodiments of the present disclosure. Although FIG. 5 illustrates various operations in an operation of an optical compensation system, embodiments according to the present disclosure are not limited thereto, and according to various embodiments, there may be additional operations, or fewer operations, or the order of operations may vary, unless otherwise stated or implied, without departing from the spirit and scope of embodiments according to the present disclosure.

In FIG. 5, a compensation method performed by the optical compensation system LCS shown in FIG. 3 is shown for each step.

Referring to FIGS. 3, 4, and 5, the sensor driving circuit SDC may detect whether the object (target object) contacts the sensor area SA based on the sensor signal, the sensor data, or the like from the sensors OPD arranged in the sensor area SA (S1). For example, the sensor driving circuit SDC may determine, from the shape, the size, or the like of the object, whether a finger tip contacts the sensor area SA. Here, each of the sensors OPD may be an optical sensor.

The sensor driving circuit SDC may detect the contact of the object and then identify the arbitrary area RA in the sensor area SA. The arbitrary area RA may be an area for identifying a portion of the sensor area SA and acquiring an image necessary, for example, for fingerprint authentication. The arbitrary area RA may be an area from which a captured image of the size sufficient for performing the fingerprint authentication may be acquired.

However, the arbitrary area RA is not limited to an area from which the captured image necessary for the fingerprint authentication may be acquired, but may be simply, for example, an area in which the sensors OPD sense that the object such as the finger tip of the user contacts the sensor area SA. In addition, the arbitrary area RA is not limited to an area sensed by the sensors OPD. The arbitrary area RA is not limited thereto, but may be, for example, a specific area requiring optical compensation, an area desired to be designated by the user, or an area designated by a control circuit including the driving controller DC. As described above, although the arbitrary area RA is not an area for acquiring a captured image unrelated to the fingerprint authentication or the arbitrary area RA is not identified by the sensors OPD, the effect of the inventive concept to be described below may be obtained by compensating for an image captured only of the arbitrary area RA based on the optical compensation data.

According to some embodiments of the present disclosure, the size of the arbitrary area RA shown in FIG. 4 may be fixed or changed. When the size of the arbitrary area RA is fixed, driving conditions of the scan driving circuit GDC and the sensor driving circuit SDC for driving the sensors OPD may be easily set. In addition, when the size of the arbitrary area RA is changed, for example, according to the area in contact with a finger tip, driving only the sensors OPD arranged in a partial area according to the size change is required and thus the power consumption of the electronic device ED may be relatively reduced.

When the arbitrary area RA is identified, the sensor driving circuit SDC may identify the coordinate information CI for the arbitrary area RA and output the coordinate information CI to the decoder DEC. Here, the coordinate information CI may correspond to the coordinates at which the sensors OPD configured to sense the object such as a finger or the like within the arbitrary area RA are arranged. According to some embodiments of the present disclosure, the decoder DEC may identify ROM addresses RCI corresponding to the received coordinate information CI (S3). The identified ROM addresses RCI may correspond to the arbitrary area RA.

The ROM addresses RCI may be the coordinate information about the compression compensation data CCD corresponding to the identified arbitrary area RA among the compression compensation data CCD stored in the memory ROM. The ROM addresses RCI may be referred to as memory coordinate information RCI. For example, in the memory ROM, the compression compensation data CCD corresponding to each of the sensors OPD arranged in the sensor area SA may be stored together with the coordinates of each of the sensors OPD, for example, the coordinate information C in the sensor area SA. Based on the coordinate information CI about the arbitrary area RA, the decoder DEC may identify the ROM addresses with reference to the coordinates of each of the sensors OPD in the sensor area SA, which are stored in the memory ROM.

A method for identifying the ROM addresses may be a column-order method, a row-order method, a tile-order method, and the like, and the identification of the ROM addresses RCI may be performed according to a method for storing the compression compensation data CCD. For example, when the method for storing the compression compensation data CCD described with reference to FIG. 4 is the column-order method, the method for identifying the ROM addresses RCI may also be the column-order method.

According to some embodiments of the present disclosure, the decoder DEC may output the identified ROM addresses RCI and a read command signal DS to the memory ROM via the transmission and reception circuit SAR. The read command signal DS may be a command signal for reading, based on the ROM addresses RCI, the compression compensation data CCD stored in corresponding positions.

The read command signal DS may include a read command code, a read mode, a leading address of data to be read, or the like. The read command code may include a single mode, a dual mode, a quad mode, or the like. For example, a mode in which one bit data is read from one output in the memory ROM may be the single mode, a mode in which two bit data is read from two outputs is the dual mode, and a mode in which four bit data is read from four outputs may be the quad mode. According to some embodiments of the present disclosure, in order to read a large amount of data within a short time, the read command code including the dual mode or the quad mode may be output to the memory ROM.

In addition, the read mode may include a continuous read mode. In the continuous read mode, when the same read command code is repeated, the read command code is not transmitted again, and the leading address of the data to be read is transmitted to perform continuous reading.

According to some embodiments of the present disclosure, the transmission and reception circuit SAR activates a select signal for selecting the memory ROM, and then synchronize the select signal to a clock signal of the memory ROM to output the read command signal DS to the memory ROM. After the read command signal DS is output and a dummy period of several clocks passes, data of the continuous ROM addresses RCI may start to be read from a ROM address RCI designated as the leading address. For example, referring to FIG. 4, a leading address of the arbitrary area RA may be (X₀, Y₀), and continuous data reading may start from the leading address (X₀, Y₀).

According to some embodiments of the present disclosure, a time from the activation of the select signal to the start of the reading of the data from the leading address may be referred to as a reading overhead or an overhead. When data is read from discontinuous addresses, the overhead may be generated all the time to remarkably slow down a data reading speed. However, when the data is read from the continuous address like the inventive concept, the overhead is generated once to improve the data reading speed and relatively reduce the data reading time. The overhead may be a preparation period for accurate reading. For example, adjustment or the like may be performed to stabilize the clock in the overhead.

When the memory ROM receives the read command signal DS from the transmission and reception circuit SAR of the decoder DEC, continuous data reading from the leading address may be performed (S5). For example, a ROM control circuit performing writing and reading of data to and from the memory ROM initiates reading based on the read command signal DS and the ROM address RCI after a dummy period of several clocks passes after the activation of the select signal, and read the compression compensation data CCD corresponding to the arbitrary area RA.

According to the row-order method, the read data may be data of one row, and according to the tile-order method, the read data may be data of each tile. The ROM control circuit may output the read data to the transmission and reception circuit SAR of the decoder DEC. Hereinafter, the read data may be the compression compensation data CCD corresponding to the arbitrary area RA.

Before reconstructing the compression compensation data CCD corresponding to the arbitrary area RA, the reconstruction circuit DECC may receive the necessary information for reconstruction RNI from the memory SRAM1 (S6). According to some embodiments of the present disclosure, a period in which the necessary information for reconstruction RNI is output may overlap an overhead period. Accordingly, the reconstruction circuit DECC may receive the necessary information for reconstruction RNI from the first memory SRAM1 in the overhead period, which may not cause a time loss in comparison to a case of separately receiving the necessary information for reconstruction RNI. For example, when receiving the compression compensation data CCD after the overhead period and then receiving the necessary information for reconstruction RNI, the reconstruction circuit DECC may reconstruct the compression compensation data CCD only after the overhead period and after at least a time A for receiving the compression compensation data CCD and a time B for receiving the necessary information for reconstruction RNI pass. However, according to the above-described method, the reconstruction circuit DECC receives in advance the necessary information for reconstruction RNI in the overhead period, and thus when the compression compensation data CCD is received after the overhead period, the reconstruction circuit DECC may immediately reconstruct the compression compensation data CCD using the necessary information for reconstruction RNI. Accordingly, as the time loss according to receiving the necessary information for reconstruction RNI may be relatively reduced, the data reconstruction speed performed in the reconstruction circuit DECC may increase. Namely, the total time including a time for reconstructing the compression compensation data CCD, a time required for reading the data, a time necessary for reconstruction, and the like may be relatively reduced.

The reconstruction circuit DECC may reconstruct, namely, decode the compression compensation data CCD corresponding to the arbitrary area RA using the necessary information for reconstruction RNI received from the first memory SRAM1 and the compression compensation data CCD corresponding to the arbitrary area RA received from the transmission and reception circuit SAR (S7). Here, the reconstruction order may also be performed through the column-order method, the row-order method, and the tile-order method.

The reconstructed data RCD may be the reconstructed compensation data RCD described in FIG. 3, and sequentially output to the second memory SRAM2 in the reconstruction order. According to some embodiments of the present disclosure, the second memory SRAM2 may output the stored reconstruction compensation data RCD as the optical compensation data ELCD to the sensor driving circuit SDC.

When all the compression compensation data CCD corresponding to the arbitrary area RA is reconstructed, the reconstruction may be finished (S8). According to some embodiments of the present disclosure, the finish of the reconstruction may be determined according to whether all the compression compensation data CCD corresponding to the arbitrary area RA is reconstructed through the column-order method, the row-order method, and the tile-order method. When all the compression compensation data CCD corresponding to the arbitrary area RA is not reconstructed, the reconstruction may be performed again from the identification of the ROM address RCI.

When the reconstruction is finished, an image capturing may be performed in the display panel DP (S9). According to some embodiments of the present disclosure, when the arbitrary area RA is identified, the image capturing may be performed only on the arbitrary area RA. When the image capturing is performed only on the arbitrary area RA, the sensor driving circuit SDC may generate sensor data only for the sensors OPD arranged in the arbitrary area RA, and cause only the sensors OPD arranged in the arbitrary area RA to be driven.

When the sensor data corresponding to the arbitrary area RA is generated, the sensor driving circuit SDC may perform the optical compensation calculation using the sensor data generated by the sensor driving circuit SDC and the optical compensation data ELCD received from the second memory SRAM2. The sensor driving circuit SDC may finish the optical compensation calculation to generate the optically compensated sensor data LCSD. In addition, the optically compensated image captured of the arbitrary area RA may be generated using the optically compensated sensor data LCSD of the arbitrary area RA.

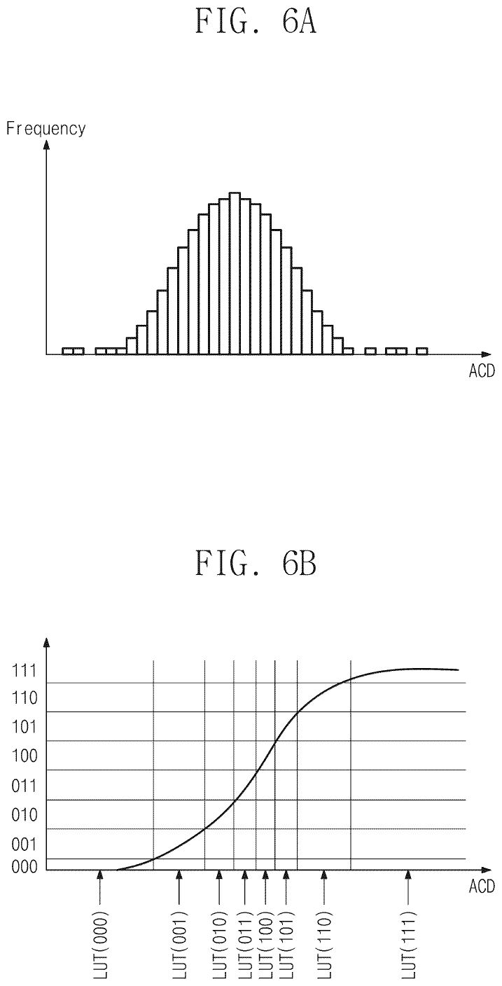

FIG. 6A is a graph for explaining an optical compensation data compression algorithm according to some embodiments of the present disclosure. FIG. 6B is a graph for explaining an optical compensation data compression algorithm according to some embodiments of the present disclosure.

Referring to FIGS. 6A and 6B, the optical compensation data may be offset data that is deviations in the sensor data when light of a specific luminance enters the sensors OPD (see FIG. 2). According to some embodiments of the present disclosure, the offset data, which is the optical compensation data, may be divided into direct current (DC) component data and alternating current (AC) component data ACD.

According to some embodiments of the present disclosure, the DC component data may be mean value data described in FIG. 3, and may be the necessary information for reconstruction RNI. The AC component data ACD of the offset data may be data except for the DC component data in the offset data. Accordingly, the data compressed in the memory ROM may be the AC component data ACD of the offset data.

Referring to FIG. 6A, the AC component data ACD may have a spatially random distribution, and typically a normal distribution. Accordingly, in compressing the AC component data ACD, a nonlinear quantization process may be used for dividing the amplitude intervals of an analog signal and representing the divided intervals with representative values. Here, the quantized data may be referred to as distribution data.

Referring to FIG. 6B, in compressing the AC component data ACD, a range of the distribution data may be determined so that each code may be assigned with the same probability or a similar probability. For example, in case of three bits, each code may be 000, 001, 010, 011, 100, 101, 110, or 111, and when the number of pieces of the distribution data is 800, the distribution data range may be determined so that 100 pieces of distribution data may be assigned for each code. FIG. 6B shows a cumulative distribution of the distribution data.

According to some embodiments of the present disclosure, the distribution data may be encoded to a code according to each range. For example, the distribution data to the hundredth data may be encoded to a code 000. The encoded data may be stored in the memory ROM as the compression compensation data CCD.

According to some embodiments of the present disclosure, representative value data LUT(000), LUT(001), . . . , LUT(111) among the pieces of distribution data corresponding to each range may be quantization error correction data, which may be stored in the first memory SRAM1 as the necessary information for reconstruction RNI. Here, the representative value data LUT(000), LUT(001), . . . , LUT(111) may be mean values, median values, values with a minimum square error, or the like of the distribution data corresponding to the respective ranges.

In addition to the aforementioned compression algorithm, some embodiments of the present disclosure may have separate representative data LUT(000), LUT(001), . . . , LUT(111) for each column, each row, or each tile of the optical compensation data. In addition, it is also possible to provide the configuration in which a plurality of pieces of representative value data LUT(000), LUT(001), . . . , LUT(111) are provided, and pieces of optimal representative value data LUT(000), LUT(001), . . . , LUT(111) are selected for respective columns, respective rows, or respective tiles. According to some embodiments of the present disclosure, it is also possible to provide the configuration in which a value range is reformed to be fit to a value range on the basis of standardized representative value data LUT(000), LUT(001), . . . , LUT(111). The reformation may be to generate change data by multiplying the representative value data LUT(000), LUT(001), . . . , LUT(111) by coefficients. Here, the coefficients may be referred to as the reformation data (or scale data). Here, the representative value data LUT(000), LUT(001), . . . , LUT(111), the reformation data, or the like may be stored in the first memory SRAM1 as the necessary information for reconstruction RNI.

As described in FIG. 2, the optical compensation data may vary according to deviations of the production quality when the sensors OPD (see FIG. 2) are manufactured. In addition, the optical compensation data may randomly vary within the sensor area SA. Accordingly, the compression algorithm like the inventive concept may be advantageous in reducing an error due to the compression of the optical compensation data.

In addition, the optical compensation data may be gain data representing a ratio of an increase of the sensor data over an increase of the luminance of light entering the sensors OPD (see FIG. 2). The gain data may also be used in the same compression algorithm as the offset data.

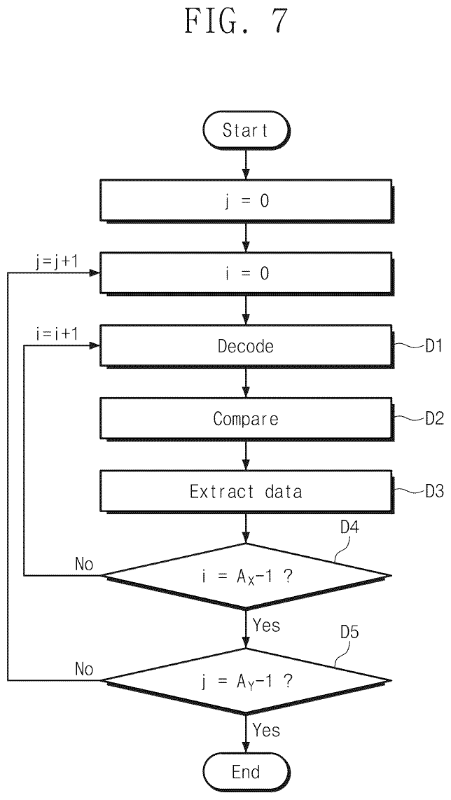

FIG. 7 is a flowchart for explaining aspects of a reconstruction algorithm or method according to some embodiments of the present disclosure. Although FIG. 7 illustrates various operations in a reconstruction method, embodiments according to the present disclosure are not limited thereto, and according to various embodiments, there may be additional operations, or fewer operations, or the order of operations may vary, unless otherwise stated or implied, without departing from the spirit and scope of embodiments according to the present disclosure.

Referring to FIGS. 3, 4, and 7, variables corresponding to the coordinates of the sensors OPD arranged in the arbitrary area RA may be set as i and j (where i=0 to Aₓ−1 and j=0 to A_{y}−1). According to some embodiments of the present disclosure, an initial state may be set as i=0 and j=0. The coordinates in the initial state may be (X₀, Y₀) that is the left upper end of the arbitrary area RA.

Referring to FIG. 6B together, the reconstruction circuit DECC may reconstruct the compression compensation data CCD of the coordinates (X₀+i, Y₀+j) received from the memory ROM using the necessary information for reconstruction RNI such as the representative value data LUT(000), LUT(001), . . . , LUT(111).

According to some embodiments of the present disclosure, the representative value data LUT(000), LUT(001), . . . , LUT(111) corresponding to the coordinates (X₀+i, Y₀+j) may be compared with the representative value data LUT(000), LUT(001), . . . , LUT(111) corresponding to a row Y₀+j (D2). Here, when there is outlier data, the compression compensation data CCD of the coordinates having the outlier data among the data of the row Y₀+j may be reconstructed using the outlier data (D3). When there is not outlier data, the compression compensation data CCD may be reconstructed using corresponding representative value data LUT(000), LUT(001), . . . , LUT(111) (D3).

After determining whether all the compression compensation data CCD of the row Y₀+j, the reconstruction circuit DECC may repeat reconstruction of the next column of the row Y₀+j (D4). Namely, the reconstruction circuit DECC may repeat the reconstruction Aₓ (i=0 to Aₓ−1) times.

When the reconstruction of the row Y₀+j is finished, the reconstruction circuit DECC may determine whether all the compression compensation data CCD of all the rows is reconstructed, and then repeat reconstruction of unreconstructed rows (D5). Namely, the reconstruction circuit DECC may repeat the reconstruction A_{y} (j=0 to A_{y}−1) times, and when the compression compensation data CCD of all the rows is reconstructed, the reconstruction may be finished.

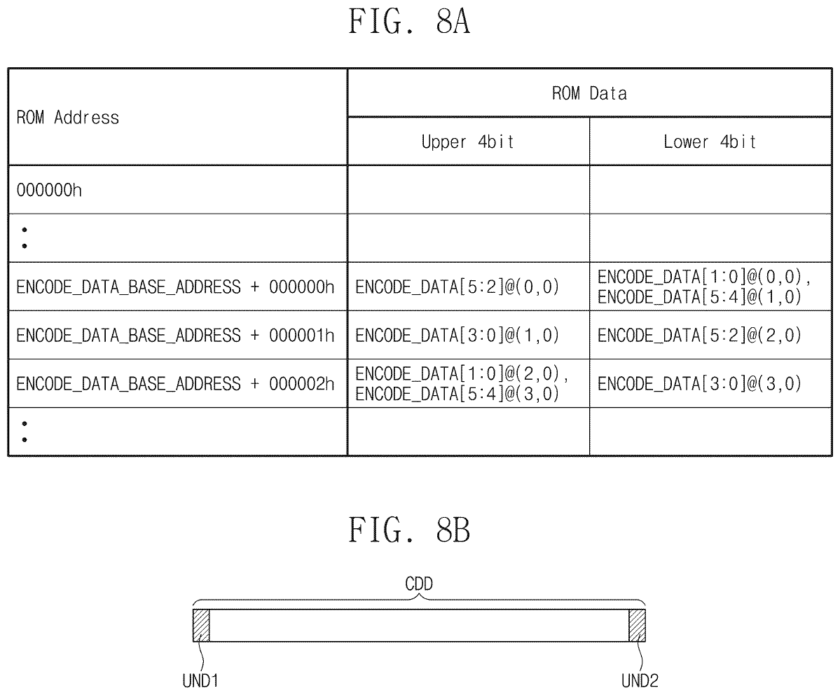

FIG. 8A is a drawing for explaining a method for calculating the ROM addresses RCI according to some embodiments of the present disclosure. FIG. 8B is a drawing for explaining a method for calculating the ROM addresses RCI according to some embodiments of the present disclosure.

Referring to FIGS. 3, 4, 8A, and 8B, the ROM addresses RCI representing the coordinates of the compression compensation data CCD stored in the memory ROM may be units of 8 bits (1 byte). Accordingly, when the compression compensation data CCD is units of bits other than 8 bits and the coordinates of the compression compensation data CCD are stored sequentially, one piece of compression compensation data CCD may be stored with a plurality of ROM addresses RCI.

According to some embodiments of the present disclosure, as shown in FIG. 8A, an example case in which the compression compensation data CCD is units of 6 bits will be described. When the compression compensation data CCD is units of 6 bits, the compression compensation data CCD of the coordinates (0, 0) may be stored with one ROM address RCI, but the compression compensation data CCD of the coordinates (0, 0) may be stored with two ROM addresses RCI. This may be the same as the compression compensation data CCD at the coordinates (2, 0) and the coordinates (3, 0)

Accordingly, as shown in FIG. 8B, when reading the compression compensation data CCD with the continuous ROM addresses RCI, pieces of unnecessary compression compensation data UND1 and UND2 may be read. The reading of the pieces of unnecessary compression compensation data UND1 and UND2 may cause a time loss, but the inventive concept may prevent or reduce a substantial time loss by reading a large amount of the compression compensation data CCD with the continuous ROM addresses RCI.

Some embodiments of the present disclosure may calculate the number of bits of the unnecessary leading data UND1, the number of bits of the unnecessary final data UND2, and the number of clocks required for reading when reading the compression compensation data CCD.

The compression compensation data CCD may have the units of N bits and be stored in the order of (x, y) coordinates from the initial address of the ROM address RCI. Here, the ROM address RCI may be provided in the units of 8-bit (1 byte) data, and be described with an example quad mode in which every four bits are read for each clock.

According to some embodiments of the present disclosure, when the compression compensation data CCD of a y-th row (y=0 to A_{y}−1) of the arbitrary area RA, namely, the coordinates of the sensors OPD (x, y)=(X₀, Y₀+y) to (X₀+Aₓ−1, Y₀+y) are read, the initial ROM address RCI may be calculated as an initial address+(((X_{S}*(Y₀+y)+X₀)*N)>>3). In addition, the number of clocks required for reading may be calculated as (((X_{S}*(Y₀+y)+X₀+Aₓ)*N+3)>>2)−((((X_{S}*(Y₀+y)+X₀)*N)>>3)*2).

According to some embodiments of the present disclosure, the number of bits of the unnecessary leading data UND1 may be calculated as ((X_{S}*(Y₀+y)+X₀)*N)−((((X_{S}*(Y₀+y)+X₀)*N)>>3)*8), and the number of bits of the unnecessary final data UND2 may be calculated as ((((X_{S}*(Y₀+y)+X₀+Aₓ)*N+3)>>2)*4)−((X_{S}*(Y₀+y)+X₀+Aₓ)*N).

As described above, in reading the compression compensation data CCD, the number of bits of the unnecessary leading data UND1, the number of bits of the unnecessary final data UND2, and the number of clocks required for reading become clear to improve the reliability of the decoder DEC.

FIG. 9 is a block diagram of the design of the decoder DEC according to some embodiments of the present disclosure.

Referring to FIGS. 3, 4, 6B, and 9, the decoder DEC may include a clock circuit CLK. The clock circuit CLK may output clock signals to circuits included in the decoder DEC.

The first memory SRAM1 may include a (1-1)-th memory SRAM1-1, a (1-2)-th memory SRAM1-2, a (1-3)-th memory SRAM1-3, a (1-4)-th memory SRAM1-4, a (1-5)-th memory SRAM1-5, and a (1-6)-th memory SRAM1-6. Hereinafter, in describing FIG. 9, the description described in FIG. 6B is also referred.

The (1-1)-th memory SRAM1-1 may store an encoding number used for compressing the optical compensation data. For example, the (1-1)-th memory SRAM1-1 may store an encoding number used for compressing the AC component data ACD. The (1-2)-th memory SRAM1-2 may store the necessary information for reconstruction RNI about the compression compensation data CCD. For example, the (1-2)-th memory SRAM1-2 may store the representative value data LUT(000), LUT(001), . . . , LUT(111) required to reconstruct the compression compensation data CCD.

The (1-3)-th memory SRAM1-3 may store the reformation data for the standardized representative value data LUT(000), LUT(001), . . . , LUT(111). Here, the reformation data may be the reformation coefficients (or scale coefficients). The (1-4)-th memory SRAM1-4 may store the number of pieces of outlier data. The (1-5)-th memory SRAM1-5 may store the outlier data and the coordinates of the outlier data. The (1-6)-th memory SRAM1-6 may store the DC component data.

According to some embodiments of the present disclosure, the decoder DEC may output the ROM addresses RCI identified as the memory ROM and the read command signal CS via the transmission and reception circuit SAR. The transmission and reception circuit SAR may sequentially receive and output each of the signals via a FIFO circuit FIFO. The signals output from the FIFO circuit FIFO may be transferred to a first interface circuit IFC1 via an initial loader circuit IR. The reconstruction circuit DECC may transmit and receive signals with the (1-1)-th to (1-6)-th memories (SRAM1-1 to SRAM1-6) via the first interface circuit IFC1.

A first circuit portion CC1 of the reconstruction circuit DECC may read the number of pieces of outlier data of a corresponding row from the (1-4)-th memory SRAM1-4 and store the number in a register during the overhead period. In addition, the first circuit portion CC1 may read the outlier data and the coordinates of the outlier data from the (1-5)-th memory SRAM1-5 and store the outlier data and the coordinates in a register.

A second circuit portion CC2 of the reconstruction circuit DECC may read the DC component data of a corresponding row from the (1-6)-th memory SRAM1-6 and store the DC component data in a register during the overhead period. According to some embodiments of the present disclosure, the above-described number of the pieces of outlier data, the outlier data, the coordinates of the outlier data, and the DC component data may be stored in the respective registers.

According to some embodiments of the present disclosure, the number of the pieces of outlier data stored in the (1-4)-th memory SRAM1-4 may be the number of pieces of outlier data from a first row to the corresponding row, and the outlier data stored in the (1-5)-th memory SRAM1-5 may be stored from the first row to the corresponding row in the order of the coordinates of the sensors OPD In addition, the coordinates of the outlier data stored in the (1-5)-th memory SRAM1-5 may have only x-coordinate. For example, when a-row data is reconstructed, the number of pieces of outlier data to an (a-1)-th row and the number of pieces of a-th row outlier data may be read from the (1-4)-th memory SRAM1-4 and compared, the outlier data and the coordinates of the outlier data may be read from the (1-5)-th memory SRAM1-5, and all the a-th row outlier data and the x-coordinate may be stored.

According to some embodiments of the present disclosure, the compression compensation data CCD may be sequentially read from the memory ROM via the transmission and reception circuit SAR to be stored in (inserted or pushed into) the FIFO circuit FIFO. Every time an N-bit share corresponding to the compression compensation data CCD is additionally stored in (inserted or pushed into) the FIFO circuit FIFO, the FIFO circuit FIFO transmits new N-bit data to a first circuit CLC1, and a second circuit CLC2 updates the coordinates. Namely, the first circuit CLC1 transmits the compression compensation data CCD in the order of the coordinates, and the second circuit CLC2 transmits the coordinates of the compression compensation data CCD. A third circuit portion CC3 of the reconstruction circuit DECC may read the encoding number from the (1-1)-th memory SRAM1-1 in correspondence to the coordinates of the compression compensation data CCD.

A fourth circuit portion CC4 of the reconstruction circuit DECC may use the encoding number and the compression compensation data CCD to read, from the (1-2)-th memory SRAM1-2, the representative value data LUT(000), LUT(001), . . . , LUT(111) that is the necessary information for reconstruction RNI. The encoding number may be assigned to each row or a range of each row, and thus the optimal representative value data LUT(000), LUT(001), . . . , LUT(111) may be selected.

A fifth circuit portion CC5 of the reconstruction circuit DECC may read the reformation coefficients (or scale coefficients) for the standardized representative value data LUT(000), LUT(001), . . . , LUT(111) from the (1-3)-th memory SRAM-1 in correspondence to the coordinates of the compression compensation data CCD. A sixth circuit portion CC6 of the reconstruction circuit DECC may generate first data DAT1 using the reformation coefficients (or scale coefficients) and a value read from the (1-2)-th memory SRAM1-2.

According to some embodiments of the present disclosure, a seventh circuit portion CC7 of the reconstruction circuit DECC may determine whether the x-coordinate of the compression compensation data CCD matches any one of the x-coordinates of the outlier data stored in the above-described register. When there is corresponding outlier data, the outlier data may be generated as second data DAT2, and when there is not the corresponding outlier data, the first data DAT1 may be used.

According to some embodiments of the present disclosure, an eighth circuit portion CC8 of the reconstruction circuit DECC may add the first data DAT1 or the second data DAT2 to the DC component data to generate the offset data OFFD among the pieces of reconstruction compensation data RCD. Here, the DC component data may be read from the (1-6)-th memory SRAM1-6.

According to some embodiments of the present disclosure, a ninth circuit portion CC9 of the reconstruction circuit DECC may calculate the gain data GAIND based on the offset data OFFD. For example, the gain data GAIND and the offset data OFFD may be in a first order transformation equation relationship.

The reconstruction compensation data RCD may include the offset data OFFD and the gain data GAIND. The offset data OFFD and the gain data GAIND may be stored in the second memory SRAM 2 in correspondence to the coordinates of the sensors OPD.

The second memory SRAM2 may include a (2-1)-th memory SRAM2-1 and a (2-2)-th memory SRAM2-2, the (2-1)-th memory SRAM2-1 may store the offset data OFFD, and the (2-2)-th memory SRAM2-2 may store the gain data GAIND. While repeating the above-described reconstruction, the decoder DEC may finally finish the reconstruction.

The reconstruction circuit DECC may transmit and receive signals with the (2-1)-th and (2-2)-th memories (SRAM2-1 and SRAM2-2) via a second interface circuit IFC2.

The operations of the first circuit CLC1, the second circuit CLC2, and the third to ninth circuit portions CC3, CC4, CC5, CC6, CC7, CC8, and CC9 may be processed in a pipeline method. Accordingly, the decoding operation may be performed more efficiently.

In the inventive concept, an image captured only of an arbitrary area is compensated, and thus the effects of reducing power consumption and improving the reconstruction speed may be obtained. Accordingly, as long as data required for compensating for the image captured only of the arbitrary area may be acquired and the calculations may be performed, the type and calculation method for the required data are not limited. For example, the optical compensation data stored in the memory ROM may not be necessarily extruded. However, storing the compression compensation data CCD, which has been compressed, in the memory ROM may be advantageous in reducing the memory storage space. In addition, the reconstruction circuit DECC may receive the necessary information for reconstruction RNI in another period other than the overhead period. However, it may be more advantageous in reducing the entire reconstruction time that the reconstruction circuit DECC receives in advance the necessary information for reconstruction RNI.

According to the described above, the electronic device may include a display panel, a decoder, and a memory. In order to detect whether an object contacts the sensor area, an arbitrary area may be identified in the display panel to acquire a necessary image (or data). The decoder may receive coordinate information of the arbitrary area from the display panel, and receive the corresponding compression compensation data from the memory.

The reconstruction circuit of the decoder may generate and output reconstruction compensation data using the compression compensation data corresponding to the arbitrary area, and information that is stored in the first memory of the decoder, corresponds to the arbitrary area, and is required for reconstruction.

In this way, the electronic device may compensate for an image captured only of the arbitrary area, thereby relatively reducing power consumption and increasing the reconstruction speed. In addition, in compressing the optical compensation data, a column-order method, a row-order method, a tile-order method, or the like may be used to increase the compression ratio, and may be advantageous in terms of a memory storage space and costs.

While the present disclosure has been described with reference to aspects of some embodiments thereof, it will be clear to those of ordinary skill in the art to which embodiments according to the present disclosure pertain that various changes and modifications may be made to the described embodiments without departing from the spirit and technical area of embodiments according to the present disclosure as defined in the appended claims and their equivalents. Thus, the scope of embodiments according to the present disclosure shall not be restricted or limited by the foregoing description, but be determined by the broadest permissible interpretation of the following claims, and their equivalents.

What is claimed is:

1. An electronic device comprising:
a display panel comprising a plurality of pixels and a plurality of sensors;
a sensor driving circuit configured to drive the plurality of sensors;
a decoder configured to receive coordinate information about an arbitrary area from the sensor driving circuit; and
a memory configured to receive memory coordinate information corresponding to the arbitrary area and a read command signal from the decoder, and to output corresponding compression compensation data to the decoder,
wherein the decoder comprises:
a first memory configured to store necessary information for reconstruction of the compression compensation data;
a reconstruction circuit configured to use the compression compensation data and the necessary information for reconstruction to output reconstruction compensation data; and
a second memory configured to receive the reconstruction compensation data from the reconstruction circuit, to store the reconstruction compensation data, and to output the reconstruction compensation data to the sensor driving circuit.

2. The electronic device of claim 1, wherein
the sensor driving circuit is configured to receive sensor signals from the plurality of sensors, and to convert the sensor signals to generate sensor data, and
the sensor driving circuit is configured to perform optical compensation calculation on the sensor data using the reconstruction compensation data to generate optically compensated sensor data.

3. The electronic device of claim 1, wherein the first memory comprises a (1-1)-th memory, a (1-2)-th memory, a (1-3)-th memory, a (1-4)-th memory, a (1-5)-th memory, and a (1-6)-th memory configured to store different pieces of the necessary information for reconstruction.

4. The electronic device of claim 1, wherein the reconstruction compensation data comprises offset data and gain data.

5. The electronic device of claim 4, wherein the second memory comprises a (2-1)-th memory configured to store the offset data and a (2-2)-th memory configured to store the gain data.

6. The electronic device of claim 1, wherein each of the plurality of sensors is an optical sensor.

7. The electronic device of claim 1, wherein the arbitrary area is a necessary area for fingerprint authentication.

8. The electronic device of claim 1, wherein a period in which the necessary information for reconstruction is output from the first memory to the reconstruction circuit overlaps an overhead period.

9. The electronic device of claim 1, wherein the necessary information for reconstruction is encoding table data.

10. The electronic device of claim 1, wherein the necessary information for reconstruction is quantization error correction data.

11. The electronic device of claim 1, wherein the necessary information for reconstruction is outlier data.

12. The electronic device of claim 1, wherein the memory is a non-volatile memory, and the first memory and the second memory are volatile memories.

13. The electronic device of claim 1, wherein
the compression compensation data is data in which alternating current component data is compressed, and
the alternating current component data is data excluding direct current component data from optical compensation data.

14. An optical compensation system comprising:
a decoder configured to receive coordinate information about an arbitrary area; and
a memory configured to receive memory coordinate information corresponding to the arbitrary area and a read command signal from the decoder, and to output corresponding compression compensation data to the decoder,
wherein the decoder comprises:
a first memory configured to store necessary information for reconstruction of the compression compensation data;
a reconstruction circuit configured to use the compression compensation data and the necessary information for reconstruction to output reconstruction compensation data; and
a second memory configured to receive the reconstruction compensation data from the reconstruction circuit, to store the reconstruction compensation data, and to output the reconstruction compensation data;
wherein the memory is a non-volatile memory, and the first memory and the second memory are volatile memories.

15. The optical compensation system of claim 14, wherein the arbitrary area is a necessary area for fingerprint authentication.

16. The optical compensation system of claim 14, wherein a period in which the necessary information for reconstruction is output from the first memory to the reconstruction circuit overlaps an overhead period.

17. The optical compensation system of claim 14, wherein the necessary information for reconstruction is encoding table data, quantization error correction data, or outlier data.

18. An electronic device driving method comprising:
identifying an arbitrary area in contact with an object;
identifying ROM addresses corresponding to coordinate information about the arbitrary area;
performing continuous reading of data from a leading address of the ROM addresses;
reconstructing compression compensation data, which has been read, using necessary information for reconstruction to generate reconstructed data; and
performing optical compensation calculation on sensor data using the reconstructed data to generate optically compensated sensor data.

19. The electronic device driving method of claim 18, wherein the performing continuous reading of data from a leading address of the ROM addresses comprises:
calculating a number of bits of unnecessary leading data;
calculating a number of bits of unnecessary final data; and
calculating a number of clocks necessary for the reading.

20. The electronic device driving method of claim 18, wherein the reconstructing comprises:
comparing representative value data corresponding to coordinates (X₀+i, Y₀+j) with pieces of representative value data corresponding to row Y₀+j;
reconstructing, using outlier data, the compression compensation data of coordinates having the outlier data among the data of row Y₀+j when there is the outlier data;
reconstructing the compression compensation data using the corresponding representative value data when there is not the outlier data; and
repeating the reconstruction of an unreconstructed row when the reconstruction of the pieces of data of row Y₀+j is finished.
